(19) United States
(12) Patent Application Publication
(10) Pub. No.: US 2014/0355051 A1
(43) Pub. Date: Dec. 4, 2014

(54) APPARATUS MANAGEMENT SYSTEM, ELECTRONIC APPARATUS, APPARATUS MANAGEMENT METHOD, AND COMPUTER READABLE RECORDING MEDIUM STORING AN APPARATUS MANAGEMENT PROGRAM

(71) Applicant: KYOCERA Document Solutions Inc., Osaka (JP)

(72) Inventors: Koki Nakajima, Osaka (JP); Daisuke Yoshida, Osaka (JP); Toyoaki Oku, Osaka (JP); Takeshi Nakamura, Osaka (JP); Yoshihiko Arai, Osaka (JP); Atsushi Matsumoto, Osaka (JP)

(73) Assignee: KYOCERA Document Solutions Inc., Osaka (JP)

(21) Appl. No.: 14/278,365

(22) Filed: May 15, 2014

(30) Foreign Application Priority Data
May 31, 2013 (JP) 2013-115129

(51) Int. Cl. G06F 3/12

(52) U.S. Cl. CPC G06F 3/1229; G06F 3/1285
USPC 358/1.15

(57) ABSTRACT

An agent unit acquires apparatus status information from an electronic apparatus. A remote maintenance server receives and stores the apparatus status information transmitted from the agent unit. The agent unit (a) issues a response request of whether transmission of the apparatus status information is permitted or denied to a user of the electronic apparatus when a transmission request of the apparatus status information is detected, (b1) transmits a notification that indicates that transmission of the apparatus status information is denied to the remote maintenance server without transmitting the apparatus status information if a response to the response request is received and the received response indicates that transmission of the apparatus status information is denied, and (b2) transmits the apparatus status information if a response to the response request is received and the received response indicates that transmission of the apparatus status information is permitted.

### CROSS-REFERENCE TO RELATED APPLICATIONS

This application relates to and claims priority rights from Japanese Patent Application No. 2013-115129, filed on May 31, 2013, the entire disclosures of which are hereby incorporated by reference herein.

### BACKGROUND

1. Field of the Present Disclosure

The present disclosure relates to an apparatus management system, an electronic apparatus, an apparatus management method, and an apparatus management program.

2. Description of the Related Art

In a remote monitoring system, report information produced in an image forming apparatus is transmitted to a monitoring device through a local network, and the monitoring device separately stores the report information on each image forming apparatus, and transmits the stored report information to a monitoring center through a network.

In another management system, a management apparatus informs a maintenance scheduled date and time to an image forming apparatus, and the image forming apparatus displays the maintenance scheduled date and time on an operation panel.

However, in the aforementioned system in which apparatus status information used for apparatus management is automatically transmitted from the apparatus side to the center side, a user of the apparatus can not know when such apparatus status information is transmitted and therefore can not confirm actual contents of the transmitted apparatus status information. In such situation, it is difficult to gain the user's acceptance on transmission of the apparatus status information.

### SUMMARY

An apparatus management system according to an aspect of the present disclosure includes an electronic apparatus, an agent unit, and a remote maintenance server. The agent unit acquires apparatus status information that indicates a status of the electronic apparatus from the electronic apparatus. The remote maintenance server receives and stores the apparatus status information transmitted from the agent unit. Further, the agent unit (a) issues a response request of whether transmission of the apparatus status information is permitted or denied to a user of the electronic apparatus when a transmission request of the apparatus status information is detected, (b1) transmits a notification that indicates that transmission of the apparatus status information is denied to the remote maintenance server without transmitting the apparatus status information if a response to the response request is received and the received response indicates that transmission of the apparatus status information is denied, and (b2) transmits the apparatus status information if a response to the response request is received and the received response indicates that transmission of the apparatus status information is permitted.

An electronic apparatus according to an aspect of the present disclosure includes a communication device, and an agent unit. The agent unit acquires apparatus status information that indicates a status of an electronic apparatus as a management target from the electronic apparatus, and transmits the apparatus status information to a remote maintenance server using the communication device. Further, the agent unit (a) issues a response request of whether transmission of the apparatus status information is permitted or denied to a user of the electronic apparatus when a transmission request of the apparatus status information is detected, (b1) transmits a notification that indicates that transmission of the apparatus status information is denied to the remote maintenance server without transmitting the apparatus status information if a response to the response request is received and the received response indicates that transmission of the apparatus status information is denied, and (b2) transmits the apparatus status information if a response to the response request is received and the received response indicates that transmission of the apparatus status information is permitted.

A non-transitory computer readable recording medium stores an apparatus management program. The apparatus management program causes a computer to act as an agent unit that acquires apparatus status information that indicates a status of an electronic apparatus as a management target from the electronic apparatus. The agent unit (a) issues a response request of whether transmission of the apparatus status information is permitted or denied to a user of the electronic apparatus when a transmission request of the apparatus status information is detected, (b1) transmits a notification that indicates that transmission of the apparatus status information is denied to the remote maintenance server without transmitting the apparatus status information if a response to the response request is received and the received response indicates that transmission of the apparatus status information is denied, and (b2) transmits the apparatus status information if a response to the response request is received and the received response indicates that transmission of the apparatus status information is permitted.

These and other objects, features and advantages of the present disclosure will become more apparent upon reading of the following detailed description along with the accompanied drawings.

### BRIEF DESCRIPTION OF THE DRAWINGS

FIG. 1 shows a configuration of an apparatus management system according to an embodiment of the present disclosure;

FIG. 2 shows a configuration of image forming apparatuses 101, 201 and 301 in FIG. 1;

FIG. 3 shows an example of an operation panel 11 of the image forming apparatus 101 and 201 in FIG. 1;

FIG. 4 shows an example of a digital note displayed on the operation panel 11 of the image forming apparatus 101 or 201 in FIG. 1;

FIG. 5 shows a configuration of a remote maintenance server 1 in FIG. 1;

FIG. 6 shows a behavior of an agent unit 111 in FIG. 1;

FIG. 7 shows an example of a digital note (a message screen) of a response request displayed using a digital note function; and

FIG. 8 shows an example of a content confirmation screen of apparatus status information to be transmitted that is a screen displayed when a soft key 513 in FIG. 7 is operated.

### DETAILED DESCRIPTION

Hereinafter, an embodiment according to an aspect of the present disclosure will be explained with reference to drawings.

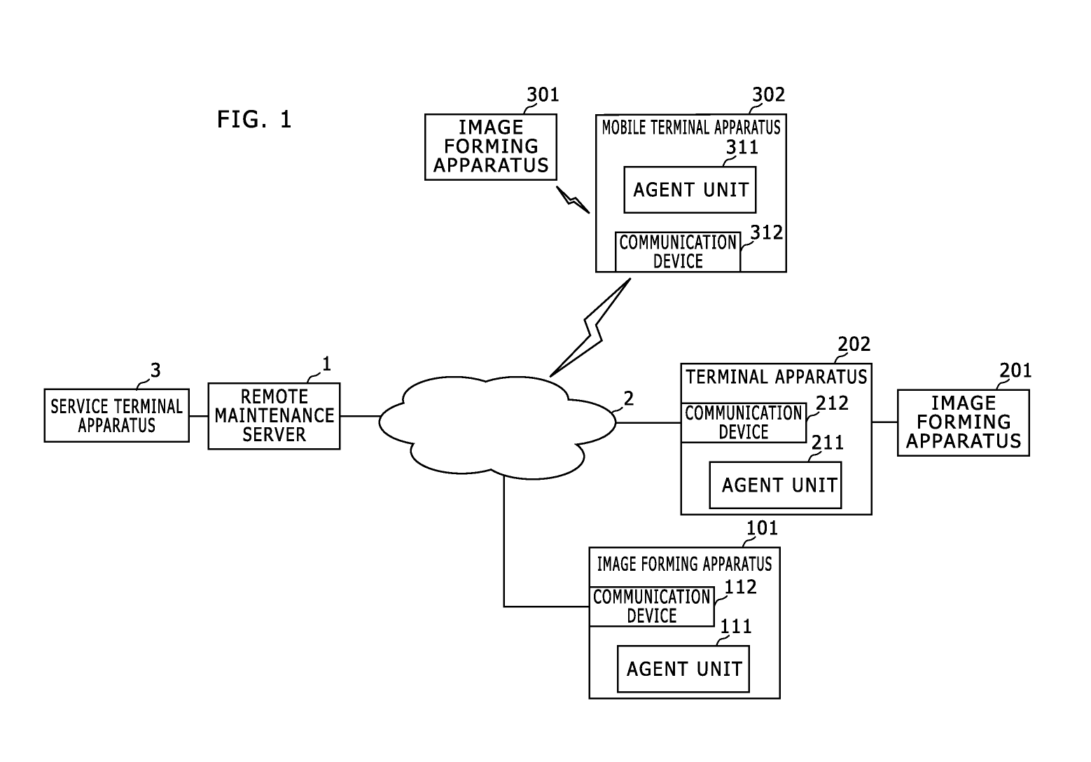

FIG. 1 shows a configuration of an apparatus management system according to an embodiment of the present disclosure. In the system shown in FIG. 1, plural image forming apparatuses 101, 201 and 301 are located on respective customer sides of maintenance service. On a maintenance service provider side, a remote maintenance server 1 is located. The remote maintenance server 1 acquires apparatus status information on the plural image forming apparatus 101, 201 and 301 for the maintenance service.

The remote maintenance server 1 is connected to a network 2. Further, the image forming apparatus 101 is connected to the network 2, the image forming apparatus 201 is connected to a terminal apparatus 202 connected to the network 2, and the image forming apparatus 301 is not connected to the network 2 and is in stand-alone status. Contrarily, a mobile terminal apparatus 302 is located near the image forming apparatus 301 and capable of wireless communication with the image forming apparatus 301 using a near field communication method. The mobile terminal apparatus 302 is also capable of connecting to the network 2 using wireless communication. The mobile terminal apparatus 302 is carried by a field service person who visits a customer's site.

The image forming apparatus 101, the terminal apparatus 202, and the mobile terminal apparatus 302 include agent units 111, 211, and 311 and communication devices 112, 212, and 312, respectively. Each one of the agent units 111, 211, and 311 is configured by executing an unshown apparatus management program using a built-in computer in the image forming apparatus 101, the terminal apparatus 202, or the mobile terminal apparatus 302. The apparatus management program is stored in an unshown non-transitory recording medium.

The agent units 111, 211 and 311 perform data communication with the remote maintenance server 1 through the network 2 using the communication devices 112, 212, and 312, respectively. Each one of the agent units 111, 211 and 311 has a snapshot function that acquires apparatus status information (also referred as a snapshot) that indicates a current status of the image forming apparatus 101, 201 or 301 and transmits the apparatus status information to the remote maintenance server 1 through the network 2.

The apparatus status information includes an event log, status information on consumable goods (i.e. a toner, a drum, or the like) in the apparatus, sorts of counter information, memory information when an error occurred (e.g. core dump), an operation log and the like.

To the remote maintenance server 1, a service terminal apparatus 3 is connected. The service terminal apparatus 3 is located, for example, in a remote service center or the like of the maintenance service provider side, used by a service person in the center, and transmits an acquisition instruction of the apparatus status information, a reading request of the acquired apparatus status information, and the like to the remote maintenance server 1 based on an operation by the service person.

Further, each one of the aforementioned agent units 111 and 211 has a digital note function that causes an operation panel of the image forming apparatus 101 or 201 to display a message screen on the basis of a message display instruction from the remote maintenance server 1. Based on an operation by a service person in the center, the service terminal apparatus 3 transmits the message display instruction and the like to the remote maintenance server 1.

Hereinafter, a message displayed using the digital note function is referred as a “digital note”. The digital note may include not only information on maintenance but advertisement and the like. The digital note is configured as a text, an image, and/or the like.

Message data of the message is produced in the service terminal apparatus 3 on the maintenance service provider side, registered in the remote maintenance server 1 from the service terminal apparatus 3, transmitted by the remote maintenance server 1, and received by the agent unit 111 or 211. A service person on the maintenance service provider side operates the service terminal apparatus 3, selects an image forming apparatus (here, for example, the image forming apparatus 101 or 201) that is caused to display a digital note, and inputs contents of the digital note. The service terminal apparatus 3 such as a personal computer produces message data of the digital note based on the operation of the service person, and registers the message data in the remote maintenance server 1.

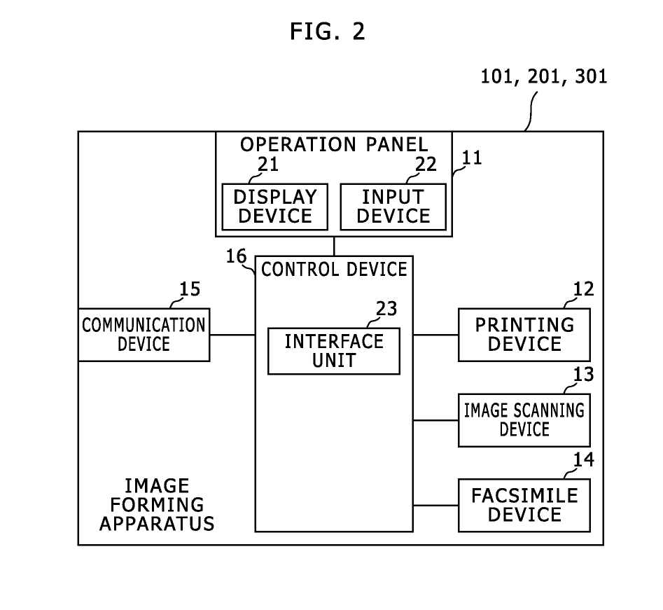

FIG. 2 shows a configuration of image forming apparatuses 101, 201 and 301 in FIG. 1.

Each one of the image forming apparatuses 101, 201 and 301 is an electronic apparatus, here, multi function peripheral.

Each one of the image forming apparatuses 101, 201 and 301 includes an operation panel 11, a printing device 12, an image scanning device 13, a facsimile device 14, a communication device 15, and a control device 16.

The operation panel 11 is arranged on a top surface of a housing of the image forming apparatus 101, 201 or 301, and includes a display device 21 that displays a screen to a user and an input device 22 that receives an operation by the user. The display device 21 includes a crystal liquid display or the like. The input device 22 includes a hard key, a touch panel that forms a soft key in cooperation with the display device 21, or the like.

The printing device 12 is an internal device that performs printing an image based on image data, for example, in an electrographic manner. The image scanning device 13 is an internal device that optically scans a document image of a document and generates image data of the document image. The facsimile device 14 is an internal device that transmits a facsimile signal of a document image and receives a facsimile signal and generates image data of a document image from the received facsimile signal. The communication device 15 includes a network interface, a modem, a peripheral device interface such as a USB (Universal Serial Bus) interface, a near field wireless communication interface such as a BlueTooth (trademark) interface, or the like.

The control device 16 includes a computer and acts as sorts of processing units by loading a program from an unshown storage device or a recording medium and executing the program. The control device 16 acts as an interface unit 23.

The interface unit 23 performs data communication with the agent unit 111 or 211 corresponding to this image forming apparatus, and has (a) a function to collect apparatus status information of this image forming apparatus based on an instruction from the agent unit 111, 211, or 311, and transmit the apparatus status information to the agent unit 111, 211, or 311, and (b) a function to display a message screen on the operation panel 11 of this image forming apparatus based on an instruction from the agent unit 111, 211, or 311, and transmit information on a user operation inputted while the message screen is displayed to the agent unit 111, 211, or 311.

It should be noted that in the image forming apparatus 101, the communication device 15 is the communication device 112, and the agent unit 111 is formed in the control device 16.

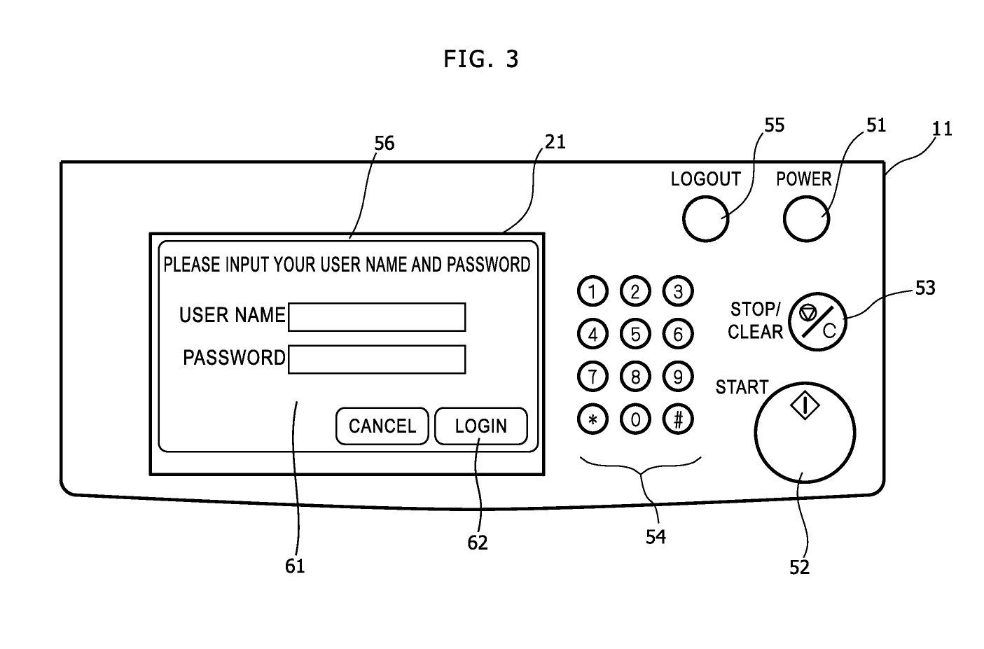

FIG. 3 shows an example of an operation panel 11 of the image forming apparatus 101 and 201 in FIG. 1. The operation panel 11 shown in FIG. 3 includes hard keys 51 to 55 and a touch panel 56 as the input device 22. The hard key 51 is a POWER key, the hard key 52 is a START key, the hard key 53 is a STOP/CLEAR key, the hard keys 54 are numeric keys, and the hard key 55 is a LOGOUT key. The touch panel 56 is arranged on a surface of the display device 21.

In FIG. 3, a login screen 61 is displayed on the display device 21 of the operation panel 11. In the login screen 61, displayed are input fields for inputting a user ID (user name) and a password, a LOGIN key 62 to cause user authentication for logging in and canceling display of the login screen 61, and so forth. For example, for inputting of a user ID and a password, numeric keys (the hard keys 54) are used.

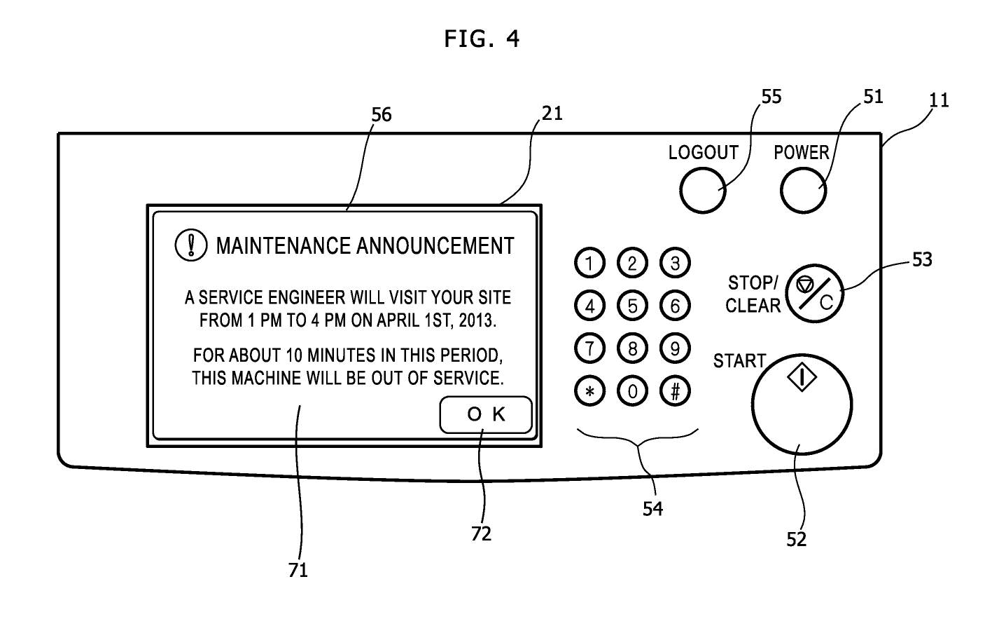

FIG. 4 shows an example of a digital note displayed on the operation panel 11 of the image forming apparatus 101 or 201 in FIG. 1. In FIG. 4, a message screen 71 is displayed on the display device 21 of the operation panel 11. In the message screen 71, displayed are a message that is a digital note (here, a text message), an OK key 72 to quit displaying the message screen 71, and so forth.

Further, when a transmission request of apparatus status information of the image forming apparatus 101 is detected, the agent unit 111 issues a response request of whether transmission of the apparatus status information is permitted or denied to a user of the image forming apparatus 101 (i.e. an electronic apparatus as a management target). If a response to the response request is received and the received response indicates that transmission of the apparatus status information is denied, the agent unit 111 transmits a notification that indicates that transmission of the apparatus status information is denied to the remote maintenance server 1 without transmitting the apparatus status information. If a response to the response request is received and the received response indicates that transmission of the apparatus status information is permitted, the agent unit 111 transmits the apparatus status information to the remote maintenance server 1.

Similarly, when a transmission request of apparatus status information of the image forming apparatus 201 is detected, the agent unit 211 issues a response request of whether transmission of the apparatus status information is permitted or denied to a user of the image forming apparatus 201 (i.e. an electronic apparatus as a management target). If a response to the response request is received and the received response indicates that transmission of the apparatus status information is denied, the agent unit 211 transmits a notification that indicates that transmission of the apparatus status information is denied to the remote maintenance server 1 without transmitting the apparatus status information. If a response to the response request is received and the received response indicates that transmission of the apparatus status information is permitted, the agent unit 211 transmits the apparatus status information to the remote maintenance server 1.

Regarding a transmission request of the apparatus status information, there are two cases: a case that a transmission request is received from the remote maintenance server 1 and a case that a transmission request is detected at a transmission timing specified by a schedule that the agent unit 111 or 211 autonomously manages.

Further, in this embodiment, each one of the agent units 111 and 211 has a digital note function that causes the operation panel 11 of the image forming apparatus 101 or 201 as a management target to display a message screen on the basis of message data received from the remote maintenance server 1. Therefore, the agent unit 111 or 211 displays a response request of whether transmission of the apparatus status information is permitted or denied as a message screen of the digital note function on the operation panel 11 of the image forming apparatus 101 or 201 as a management target. The agent unit 111 or 211 receives a response to the response request on the basis of a user operation to the operation panel 11 of the image forming apparatus 101 or 201 as a management target. If the response indicates that transmission of the apparatus status information is denied, the agent unit 111 or 211 transmits a notification that indicates that transmission of the apparatus status information is denied to the remote maintenance server 1 without transmitting the apparatus status information. If the response indicates that transmission of the apparatus status information is permitted, the agent unit 111 or 211 transmits the apparatus status information to the remote maintenance server 1.

Further, in this embodiment, the agent units 111 and 211 include respective setting data. The setting data includes a first setting item to set whether or not user confirmation is performed on whether transmission of the apparatus status information is permitted or denied, a second setting item to set whether or not user notification is performed when the apparatus status information is transmitted, and a third setting item to set a communication method used for the user confirmation and the user notification. The remote maintenance server 1 or the image forming apparatus 101 or 201 is enabled to set a value to each one of the setting items.

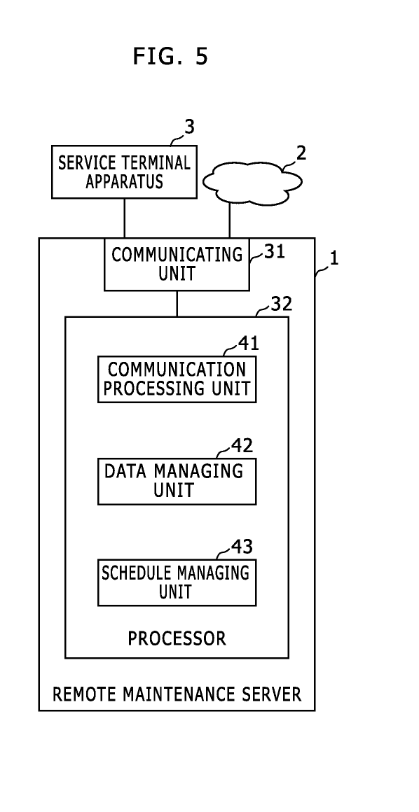

FIG. 5 shows a configuration of a remote maintenance server 1 in FIG. 1. The remote maintenance server 1 includes a communicating unit 31 and a processor 32.

The communicating unit 31 includes a communication circuit that performs data communication with the service terminal apparatus 3 and a communication circuit that performs data communication through the network 2.

The processor 32 includes a computer and acts as sorts of processing units by loading a program from an unshown storage device or a recording medium to a RAM (Random Access Memory) and executing the program with a CPU (Central Processing Unit). The processor 32 acts as a communication processing unit 41, a data managing unit 42, and a schedule managing unit 43.

The communication processing unit 41 performs data communication with the service terminal apparatus 3 and data communication with the agent units 111, 211 and 311 through the network 2 using the communicating unit 31.

The data managing unit 42 stores apparatus status information received from the agent unit 111, 211 or 311 in an unshown storage device, a database or the like.

The schedule managing unit 43 transmits an acquisition instruction of apparatus status information to the agent unit 111 or 211 corresponding to the image forming apparatus 101 or 201 as a target from which apparatus status information is acquired, and causes the agent unit 111 or 211 to transmit the apparatus status information to the remote maintenance server 1 if the acquisition of the apparatus status information succeeded.

The schedule managing unit 43 transmits an acquisition instruction based on a schedule specified by the service terminal apparatus 3 on the maintenance server provider side, and immediately transmits an acquisition instruction based on an instruction from the service terminal apparatus 3 on the maintenance service provider side.

The received apparatus status information is stored so as to relate the received apparatus status information to identification information on the image forming apparatus by the data managing unit 42, and the data managing unit 42 transmits the stored apparatus status information to the service terminal apparatus 3 as a response to a request received from the service terminal apparatus 3 on the maintenance service provider side.

The following part explains processing of the apparatus management in the system shown in FIG. 1.

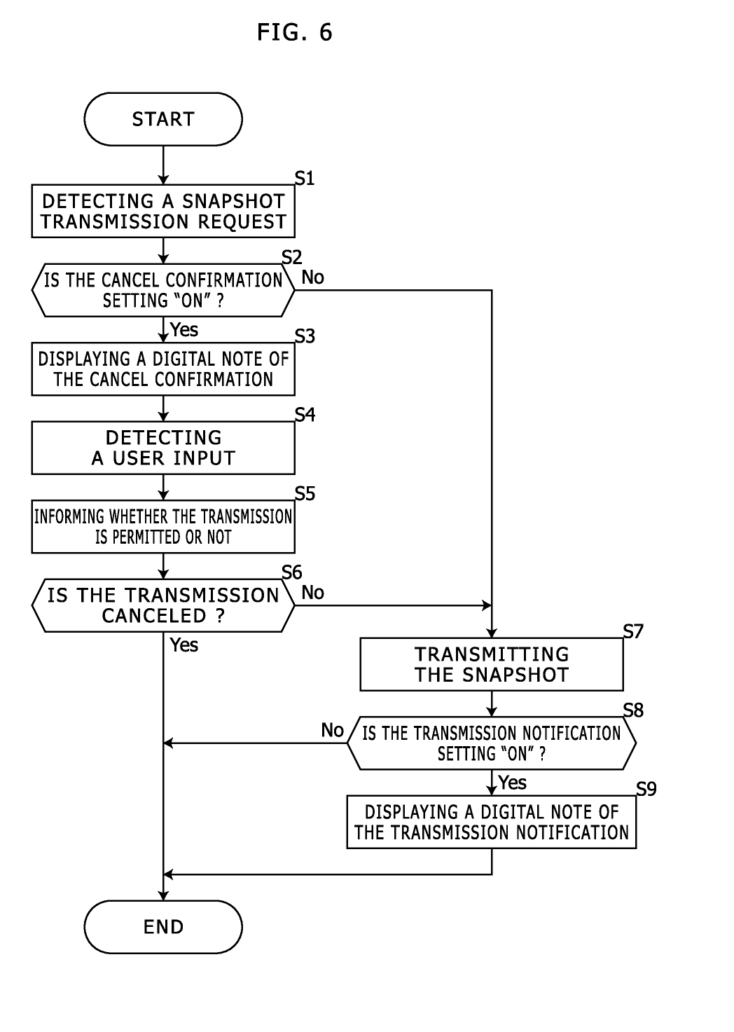

Here a behavior of the agent unit 111 is mainly explained. The agent unit 211 operates in the same manner. FIG. 6 shows a behavior of the agent unit 111 in FIG. 1.

When the agent unit 111 detects a transmission request of a snapshot (in Step S1), the agent unit 111 identifies whether or not the value of the first setting item indicates that user confirmation is performed on whether transmission of the apparatus status information is permitted or denied (in Step S2). If the value of the first setting item indicates that user confirmation is performed on whether transmission of the apparatus status information is permitted or denied, the agent unit 111 causes the operation panel 11 of the image forming apparatus 101 through the interface unit 23 to display a digital note of a response request on whether the transmission is permitted or denied using the digital note function (in Step S3).

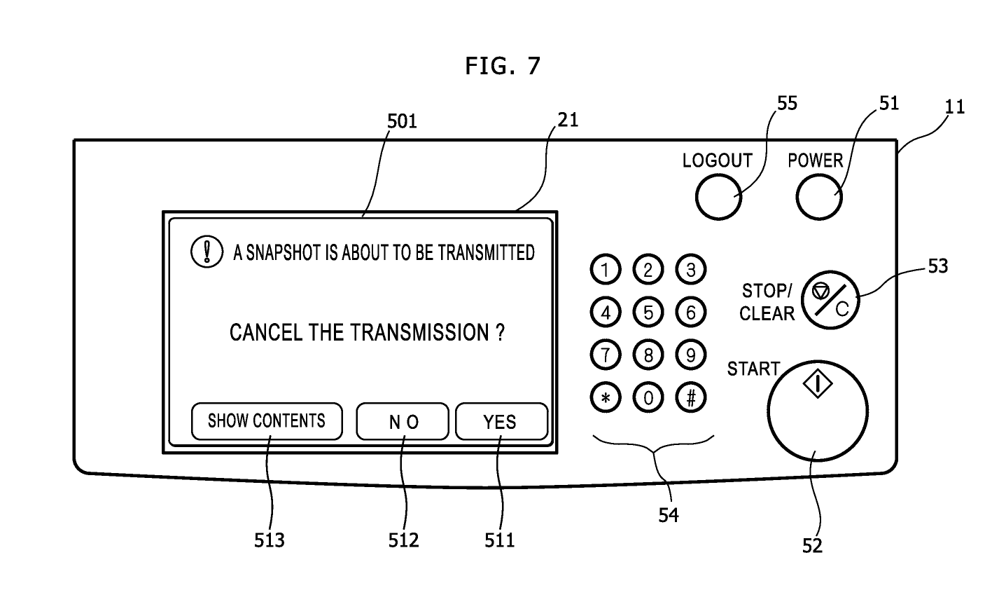

FIG. 7 shows an example of a digital note (a message screen) of a response request displayed using the digital note function. As shown in FIG. 7, the digital note 501 is displayed as one layer that overlaps a currently displayed operation screen, and includes soft keys 511, 512, and 513. The soft key 511 is used for response indicating the transmission is denied. The soft key 512 is used for response indicating the transmission is permitted. The soft key 513 is used for displaying as a digital note a content confirmation screen of the apparatus status information to be transmitted.

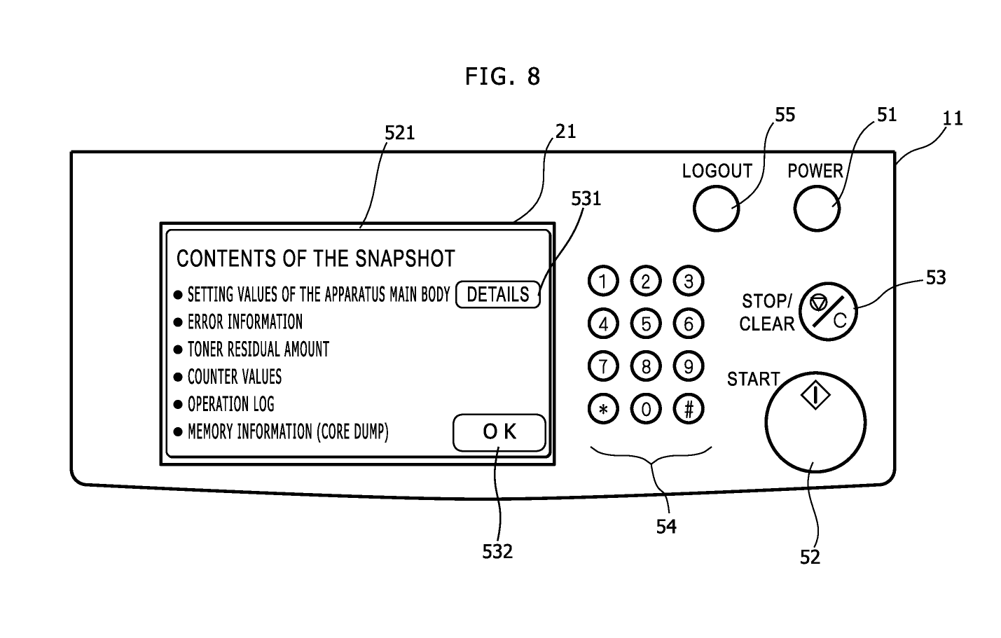

When the soft key 513 is operated, the agent unit 111 causes the operation panel 11 to display a digital note that includes a content confirmation screen that indicates contents of the apparatus status information to be transmitted. FIG. 8 shows an example of a content confirmation screen of apparatus status information to be transmitted that is a screen displayed when the soft key 513 in FIG. 7 is operated. As shown in FIG. 8, the digital note 521 is displayed as one layer that overlaps the digital note 501, and displays items included in the apparatus status information and includes soft keys 531 and 532. The soft key 531 is used for displaying details on a corresponding item as a digital note in the same manner. The soft key 532 is used for deleting the digital note 521. It should be noted that if the digital note 521 is deleted, then the digital note 501 is displayed again.

Subsequently, for example, if the soft key 511 or the soft key 512 in FIG. 7 is operated, the agent unit 111 receives a response based on this operation through the interface unit 23 (in Step S4), and deletes the digital note 501. It should be noted that if the digital note 501 is deleted, then the original operation screen is displayed again.

When receiving the response, the agent unit 111 informs the remote maintenance server 1 of whether the transmission is permitted or denied on the basis of the response (in Step S5). If the response indicates that the transmission is denied (i.e. cancel of the transmission) (in Step S6), the agent unit 111 terminates this processing without transmitting the apparatus status information.

Contrarily, if the response indicates that the transmission is permitted (in Step S6), the agent unit 111 acquires the apparatus status information from the interface unit 23 and transmits the acquired apparatus status information to the remote maintenance server 1 (in Step S7).

In Step S2, if the value of the first setting item does not indicate that user confirmation is performed on whether transmission of the apparatus status information is permitted or denied, the agent unit 111 immediately acquires the apparatus status information from the interface unit 23 and immediately transmits the acquired apparatus status information to the remote maintenance server 1 (in Step S7).

Subsequently, the agent unit 111 identifies whether the value of the second setting item indicates that user notification is performed when the apparatus status information is transmitted (in Step S8). If the value of the second setting item does not indicate that user notification is performed when the apparatus status information is transmitted, the agent unit 111 terminates this processing without transmission notification of the apparatus status information.

Contrarily, if the value of the second setting item indicates that user notification is performed when the apparatus status information is transmitted, the agent unit 111 causes the operation panel 11 through the interface unit 23 to display a digital note of a transmission notification of the apparatus status information using the digital note function (in Step S9). If the apparatus status information was transmitted without the response request, the digital note of the transmission notification may include contents of the transmitted apparatus status information.

In the aforementioned embodiment, when a transmission request of apparatus status information of the image forming apparatus 101 or 201 is detected, the agent unit 111 or 211 issues a response request of whether transmission of the apparatus status information is permitted or denied to a user of the image forming apparatus 101 or 201. If a response to the response request is received and the received response indicates that transmission of the apparatus status information is denied, the agent unit 111 or 211 transmits a notification that indicates that transmission of the apparatus status information is denied to the remote maintenance server 1 without transmitting the apparatus status information. If a response to the response request is received and the received response indicates that transmission of the apparatus status information is permitted, the agent unit 111 or 211 transmits the apparatus status information to the remote maintenance server 1.

Therefore, in the apparatus management system, a user can know a transmission timing and contents of the apparatus status information to be transmitted to the maintenance service provider side.

The description has been presented for purposes of illustration and description, and is not intended to be exhaustive or limited.

For example, in the aforementioned embodiment, notification of the response request and reception of the response are performed using the digital note function. Alternatively, notification of the response request and reception of the response may be performed using email. Further, notification of the response request may be performed as printing out the response request. The communication method set in the aforementioned third setting item may be used for these purposes.

Further, in the aforementioned embodiment, the agent unit 111 or 211 may be configured so as to identify whether a user currently logs in the image forming apparatus 101 or 201 as a management target, issue a response request of whether transmission of the apparatus status information is permitted or denied to a user of the image forming apparatus 101 or 201 using the digital note function if the user currently logs in the image forming apparatus 101 or 201 as a management target, and issue a response request of whether transmission of the apparatus status information is permitted or denied to a user of the image forming apparatus 101 or 201 using a specific communication method (e.g. email) other than the digital note function if the user currently does not log in the image forming apparatus 101 or 201 as a management target. For example, if an email system is used as the aforementioned specific communication method, an email address of the user of the image forming apparatus 101 or 201 has been set and an email of the response request is transmitted to the set email address, and an email of the response is received from the email address.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An apparatus management system, comprising:
an electronic apparatus;
an agent unit that acquires apparatus status information that indicates a status of the electronic apparatus from the electronic apparatus; and
a remote maintenance server that receives and stores the apparatus status information transmitted from the agent unit;
wherein the agent unit (a) issues a response request of whether transmission of the apparatus status information is permitted or denied to a user of the electronic apparatus when a transmission request of the apparatus status information is detected, (b1) transmits a notification that indicates that transmission of the apparatus status information is denied to the remote maintenance server without transmitting the apparatus status information if a response to the response request is received and the received response indicates that transmission of the apparatus status information is denied, and (b2) transmits the apparatus status information to the remote maintenance server if a response to the response request is received and the received response indicates that transmission of the apparatus status information is permitted.

2. An electronic apparatus, comprising:
a communication device; and
an agent unit that acquires apparatus status information that indicates a status of an electronic apparatus as a management target from the electronic apparatus, and transmits the apparatus status information to a remote maintenance server using the communication device;
wherein the agent unit (a) issues a response request of whether transmission of the apparatus status information is permitted or denied to a user of the electronic apparatus when a transmission request of the apparatus status information is detected, (b1) transmits a notification that indicates that transmission of the apparatus status information is denied to the remote maintenance server without transmitting the apparatus status information if a response to the response request is received and the received response indicates that transmission of the apparatus status information is denied, and (b2) transmits the apparatus status information to the remote maintenance server if a response to the response request is received and the received response indicates that transmission of the apparatus status information is permitted.

3. The electronic apparatus according to claim 2, wherein:
the agent unit has a digital note function that displays a message screen based on message data received from the remote maintenance server on an operation panel of the electronic apparatus as a management target; and
the agent unit (c) displays the response request of whether transmission of the apparatus status information is permitted or denied as a message screen of the digital note function on the operation panel of the electronic apparatus as a management target, (d) receives a response to the response request on the basis of a user operation to the operation panel of the electronic apparatus as a management target, (e1) transmits a notification that indicates that transmission of the apparatus status information is denied to the remote maintenance server without transmitting the apparatus status information if the response indicates that transmission of the apparatus status information is denied, and (e2) transmits the apparatus status information to the remote maintenance server if the response indicates that transmission of the apparatus status information is permitted.

4. The electronic apparatus according to claim 3, wherein the agent unit displays a soft key in the message screen of the response request, displays a content confirmation screen when the soft key is operated, and the content confirmation screen indicates content of the apparatus status information to be transmitted.

5. The electronic apparatus according to claim 3, wherein the agent unit identifies whether a user currently logs in the electronic apparatus as a management target or not, issues a response request of whether transmission of the apparatus status information is permitted or denied to a user of the electronic apparatus using the digital note function if a user currently logs in the electronic apparatus as a management target, and issues a response request of whether transmission of the apparatus status information is permitted or denied to a user of the electronic apparatus using a specific communication method other than the digital note function if a user currently does not log in the electronic apparatus as a management target.

6. A non-transitory computer readable recording medium storing an apparatus management program, wherein:
the apparatus management program causes a computer to act as an agent unit that acquires apparatus status information that indicates a status of an electronic apparatus as a management target from the electronic apparatus; and
the agent unit (a) issues a response request of whether transmission of the apparatus status information is permitted or denied to a user of the electronic apparatus when a transmission request of the apparatus status information is detected, (b1) transmits a notification that indicates that transmission of the apparatus status information is denied to the remote maintenance server without transmitting the apparatus status information if a response to the response request is received and the received response indicates that transmission of the apparatus status information is denied, and (b2) transmits the apparatus status information to the remote maintenance server if a response to the response request is received and the received response indicates that transmission of the apparatus status information is permitted.
